(19) United States
(12) Patent Application Publication
(10) Pub. No.: US 2015/0163028 A1
(43) Pub. Date: Jun. 11, 2015

(54) METHODS AND APPARATUS FOR WIRELESS COMMUNICATION UTILIZING EFFICIENT SIGNAL FIELD DESIGN IN HIGH EFFICIENCY WIRELESS PACKETS

(71) Applicant: QUALCOMM Incorporated, San Diego, CA (US)

(72) Inventors: Rahul Tandra, San Diego, CA (US); Sameer Vermani, San Diego, CA (US); Bin Tian, San Diego, CA (US)

(21) Appl. No.: 14/565,238

(22) Filed: Dec. 9, 2014

Related U.S. Application Data
(60) Provisional application No. 61/914,301, filed on Dec. 10, 2013.

(51) Int. Cl. H04L 5/00; H04B 7/04

(52) U.S. Cl. CPC H04L 5/0037; H04L 5/0044; H04L 5/0023; H04B 7/0452

(57) ABSTRACT

In one aspect, a method of high efficiency wireless (HEW) communication comprises generating a packet comprising one of a first value, a second value, a third value and a fourth value in a packet type field, the first value indicating a single-user multiple-input multiple-output (SU-MIMO) packet, the second value indicating a multiple-user multiple-input multiple-output (MU-MIMO) packet, the third value indicating an orthogonal frequency division multiple access (OFDMA) packet, and the fourth value indicating a multi-portion packet comprising at least a first MU-MIMO or OFDMA portion and a second MU-MIMO or OFDMA portion. The method further comprises allocating a plurality of bits of a first portion of the packet to each of a plurality of subsequent fields based at least in part on the value in the packet type field, wherein a second portion of the packet is the same for all of the first, second, third and fourth values.

### CLAIM OF PRIORITY UNDER 35 U.S.C. §119

The present Application for Patent claims priority to Provisional Application No. 61/914,301 entitled “METHODS AND APPARATUS FOR WIRELESS COMMUNICATION UTILIZING EFFICIENT SIGNAL FIELD DESIGN IN HIGH EFFICIENCY WIRELESS PACKETS” filed Dec. 10, 2013, and assigned to the assignee hereof. Provisional Application No. 61/914,301 is hereby expressly incorporated by reference herein.

### BACKGROUND

1. Field

Certain aspects of the present disclosure generally relate to wireless communications, and more particularly, to methods and apparatus for wireless communication utilizing efficient signal field design in high efficiency wireless (HEW) packets.

2. Background

In many telecommunication systems, communications networks are used to exchange messages among several interacting spatially-separated devices. Networks may be classified according to geographic scope, which could be, for example, a metropolitan area, a local area, or a personal area. Such networks may be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

As the volume and complexity of information communicated wirelessly between multiple devices continues to increase, overhead bandwidth required for physical layer control signals continues to increase at least linearly. The number of bits utilized to convey physical layer control information has become a significant portion of required overhead. Thus, with limited communication resources, it is desirable to reduce the number of bits required to convey this physical layer control information, especially as multiple types of traffic are concurrently sent from an access point to multiple terminals. For example, when an access point sends downlink communications to multiple terminals, it is desirable to minimize the number of bits required to control the downlink of all transmissions. Thus, there is a need for an improved protocol for transmissions to and from multiple terminals.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method of high efficiency wireless (HEW) communication. The method comprises generating a packet comprising one of a first value, a second value, a third value, and a fourth value in a packet type field. The first value indicates a single-user multiple-input multiple-output (SU-MIMO) packet. The second value indicates a multiple-user multiple-input multiple-output (MU-MIMO) packet. The third value indicates an orthogonal frequency division multiple access (OFDMA) packet. The fourth value indicates a multi-portion packet comprising at least a first MU-MIMO or OFDMA portion and a second MU-MIMO or OFDMA portion. The method further comprises allocating a plurality of bits of a first portion of the packet to each of a plurality of subsequent fields based at least in part on the value in the packet type field. A second portion of the packet is the same for all of the first, second, third and fourth values

Another aspect of the disclosure provides an apparatus for high efficiency wireless (HEW) communication. The apparatus comprising a processor configured to generate a packet comprising one of a first value, a second value, a third value and a fourth value in a packet type field. The first value indicates a single-user multiple-input multiple-output (SU-MIMO) packet. The second value indicates a multiple-user multiple-input multiple-output (MU-MIMO) packet. The third value indicates an orthogonal frequency division multiple access (OFDMA) packet. The fourth value indicates a multi-portion packet comprising at least a first MU-MIMO or OFDMA portion and a second MU-MIMO or OFDMA portion. The processor is further configured to allocate a plurality of bits of a first portion of the packet to each of a plurality of subsequent fields based at least in part on the value in the packet type field. A second portion of the packet is the same for all of the first, second, third and fourth values.

Another aspect of the disclosure provides a non-transitory computer-readable medium comprising code. The code, when executed, causes an apparatus to generate a packet comprising one of a first value, a second value, a third value and a fourth value in a packet type field. The first value indicates a single-user multiple-input multiple-output (SU-MIMO) packet. The second value indicates a multiple-user multiple-input multiple-output (MU-MIMO) packet. The third value indicates an orthogonal frequency division multiple access (OFDMA) packet. The fourth value indicates a multi-portion packet comprising at least a first MU-MIMO or OFDMA portion and a second MU-MIMO or OFDMA portion. The code, when executed further causes the apparatus to allocate a plurality of bits of a first portion of the packet to each of a plurality of subsequent fields based at least in part on the value in the packet type field. A second portion of the packet is the same for all of the first, second, third and fourth values.

Another aspect of the disclosure provides an apparatus for high efficiency wireless (HEW) communication. The apparatus comprises means for generating a packet comprising one of a first value, a second value, a third value and a fourth value in a packet type field. The first value indicates a single-user multiple-input multiple-output (SU-MIMO) packet. The second value indicates a multiple-user multiple-input multiple-output (MU-MIMO) packet. The third value indicates an orthogonal frequency division multiple access (OFDMA) packet. The fourth value indicates a multi-portion packet comprising at least a first MU-MIMO or OFDMA portion and a second MU-MIMO or OFDMA portion. The apparatus further comprises means for allocating a plurality of bits of a first portion of the packet to each of a plurality of subsequent fields based at least in part on the value in the packet type field. A second portion of the packet is the same for all of the first, second, third and fourth values.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 illustrates various exemplary components that may be utilized in the packet generator based on packet type field within the wireless device of FIG. 2.

FIG. 4 illustrates a diagram of a physical layer data unit (PPDU) having a first high efficiency signal field (HE-SIG0) and a second high efficiency signal field (HE-SIG1) that may be employed within the wireless communication system of FIG. 1.

FIG. 5 illustrates a format of a HE-SIG field for a MU-MIMO PPDU, in accordance with an exemplary implementation.

FIG. 6 illustrates a format of a HE-SIG field for an OFDMA PPDU, in accordance with an exemplary implementation.

FIG. 7 illustrates a block diagram of an access point and stations in a mixed MU-MIMO and OFDMA system, in accordance with an exemplary implementation.

FIG. 8 illustrates a format of a HE-SIG field for a multi-portion PPDU, in accordance with an exemplary implementation.

FIG. 9 illustrates a format of a HE-SIG field for a SU-MIMO PPDU packet, in accordance with an exemplary implementation.

FIG. 10 is a flow chart of an aspect of a method of high efficiency wireless (HEW) communication, in accordance with an exemplary implementation.

FIG. 11 is a functional block diagram of an apparatus for wireless communication, in accordance with an exemplary implementation.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to a high-efficiency 802.11 protocol using orthogonal frequency-division multiplexing (OFDM), direct—sequence spread spectrum (DSSS) communications, a combination of OFDM and DSSS communications, or other schemes. Implementations of the high-efficiency 802.11 protocol may be used for Internet access, sensors, metering, smart grid networks, or other wireless applications. Advantageously, aspects of certain devices implementing this particular wireless protocol may consume less power than devices implementing other wireless protocols, may be used to transmit wireless signals across short distances, and/or may be able to transmit signals less likely to be blocked by objects, such as humans.

In some implementations, a WLAN includes various devices which are the components that access the wireless network. For example, there may be two types of devices: access points (“APs”) and clients (also referred to as stations, or “STAs”). In general, an AP serves as a hub or base station for the WLAN and an STA serves as a user of the WLAN. For example, a STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area networks. In some implementations an STA may also be used as an AP.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to concurrently transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, frequency bands etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) may also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

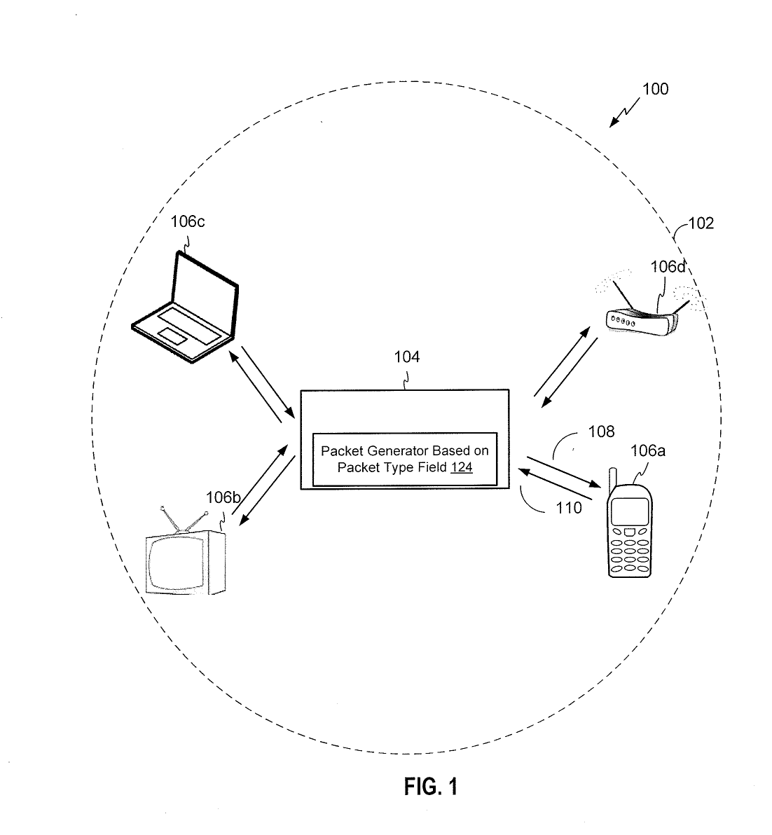

FIG. 1 illustrates an example of a wireless communication system 100 in which aspects of the present disclosure may be employed. The wireless communication system 100 may operate pursuant to a wireless standard (e.g., at least one of the 802.11ah, 802.11ac, 802.11n, 802.11g and 802.11b standards). The wireless communication system 100 may include an AP 104, which communicates with STAs 106a, 106b, 106c, and 106d (hereinafter collectively STAs 106a-106d).

A variety of processes and methods may be used for transmissions in the wireless communication system 100 between the AP 104 and the STAs 106a-106d. For example, signals may be transmitted and received between the AP 104 and the STAs 106a-106d in accordance with OFDM/OFDMA techniques. If this is the case, the wireless communication system 100 may be referred to as an OFDM/OFDMA system. Alternatively, signals may be transmitted and received between the AP 104 and the STAs 106a-106d in accordance with CDMA techniques. If this is the case, the wireless communication system 100 may be referred to as a CDMA system. Alternatively, signals may be transmitted and received between the AP 104 and the STAs 106a-106d in accordance with multiple-user multiple-input multiple-output (MU-MIMO) techniques. If this is the case, the wireless communication system 100 may be referred to as a MU-MIMO system. Alternatively, signals may be transmitted and received between the AP 104 and the STAs 106a-106d in accordance with single-user multiple-input multiple-output (SU-MIMO) techniques. If this is the case, the wireless communication system 100 may be referred to as a SU-MIMO system. Alternatively, signals may be transmitted and received between the AP 104 and the STAs 106a-106d simultaneously in accordance with MU-MIMO techniques and OFDM/OFDMA. If this is the case, the wireless communication system 100 may be referred to as a multiple-technique system.

A communication link that facilitates transmission from the AP 104 to one or more of the STAs 106a-106d may be referred to as a downlink (DL) 108, and a communication link that facilitates transmission from one or more of the STAs 106a-106d to the AP 104 may be referred to as an uplink (UL) 110. Alternatively, a downlink 108 may be referred to as a forward link or a forward channel, and an uplink 110 may be referred to as a reverse link or a reverse channel.

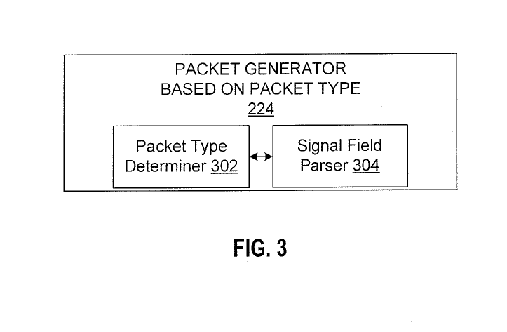

The AP 104 may include a packet generator based on packet type field 124, having a packet type determiner and a signal field parser (e.g., see FIG. 3), which may be utilized to generate a packet having a value in a packet type field that indicates the packet type, and to further allocate a plurality of bits of the packet (e.g., of a signal field in the packet) to each of a plurality of subsequent fields based at least in part on the value in the packet type field, as will be described in more detail below. Thus, as opposed to conventional operation where a particular set of bits in a signal field of a packet are always allocated to the same fields, the present application contemplates including a packet type field in the signal field having a value indicating the type of packet and then dynamically allocating at least a portion of remaining bits in the signal field of the packet to a plurality of fields, the fields allocated being based on the packet type indicated in the packet type field.

The AP 104 may provide wireless communication coverage in a basic service area (BSA) 102. The AP 104 along with the STAs 106a-106d associated with the AP 104, and that use the AP 104 for communication, may be referred to as a basic service set (BSS). It should be noted that the wireless communication system 100 may not have a central AP 104, but rather may function as a peer-to-peer network between the STAs 106a-106d. Accordingly, the functions of the AP 104 described herein may alternatively be performed by one or more of the STAs 106a-106d.

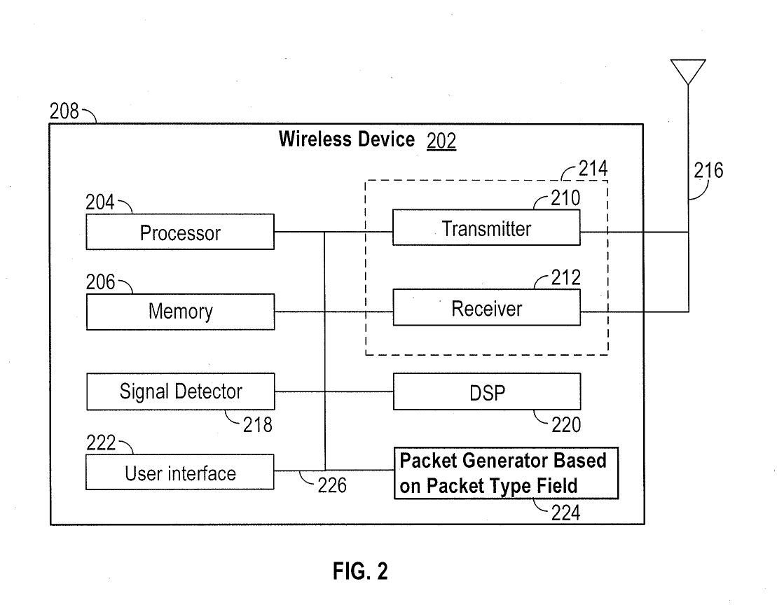

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the AP 104 or one of the STAs 106a-106d.

The wireless device 202 may include a processor 204 which controls operation of the wireless device 202. The processor 204 may also be referred to as a central processing unit (CPU) or hardware processor. Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may further comprise a packet generator based on packet type field 224, as previously described in connection with FIG. 1 (e.g., the packet generator 124). In some of those implementations, the packet generator based on packet type field 224 may utilize the processor 204 and/or the memory 206. In others of those implementations, the packet generator based on packet type field 224 may be a separate module comprising one or more separate processors and/or memories. The packet generator based on packet type field 224 may comprise a packet type determiner and a signal field parser (e.g., see FIG. 3), and may be configured to generate a packet having a value in a packet type field of a signal field of the packet that indicates the packet type, and to further allocate a plurality of bits of the signal field of the packet to each of a plurality of subsequent fields based at least in part on the value in the packet type field, as will be described in more detail below.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas, which may be utilized during multiple-input multiple-output (MIMO) communications, for example.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

As discussed above, the wireless device 202 may comprise an AP 104 or one of the

STAs 106a-106d, and may be used to transmit and/or receive communications. The communications exchanged between devices in a wireless network may include data units which may comprise packets or frames. In some aspects, the data units may include data frames, control frames, and/or management frames. Data frames may be used for transmitting data from an AP and/or a STA to other APs and/or STAs. Control frames may be used together with data frames for performing various operations and for reliably delivering data (e.g., acknowledging receipt of data, polling of APs, area-clearing operations, channel acquisition, carrier-sensing maintenance functions, etc.). Management frames may be used for various supervisory functions (e.g., for joining and departing from wireless networks, etc.).

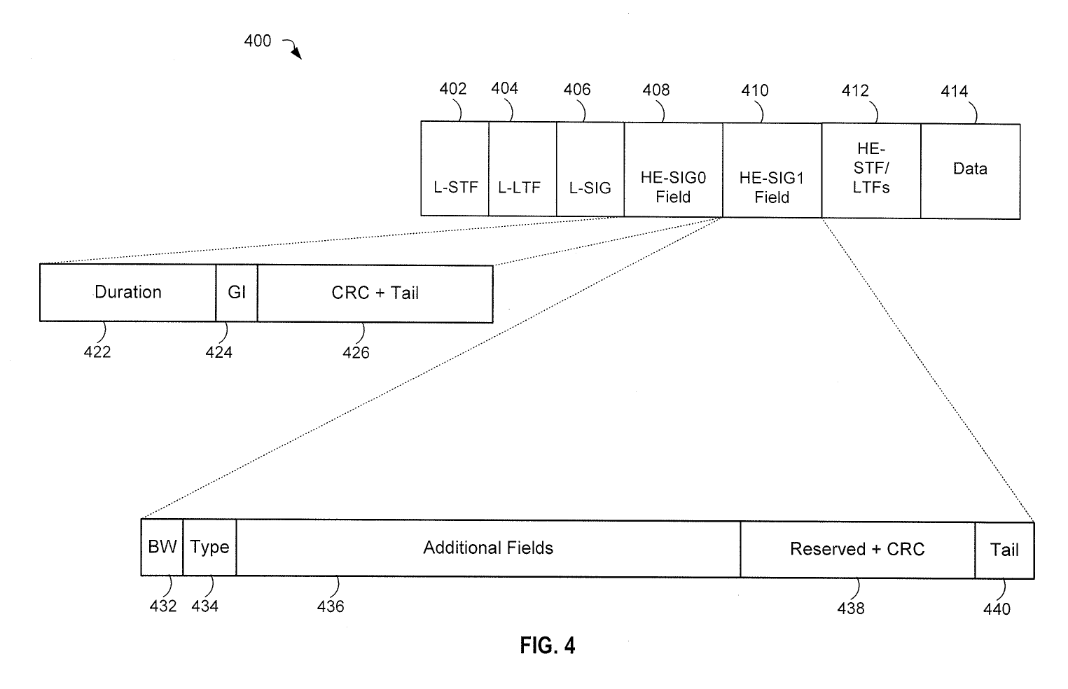

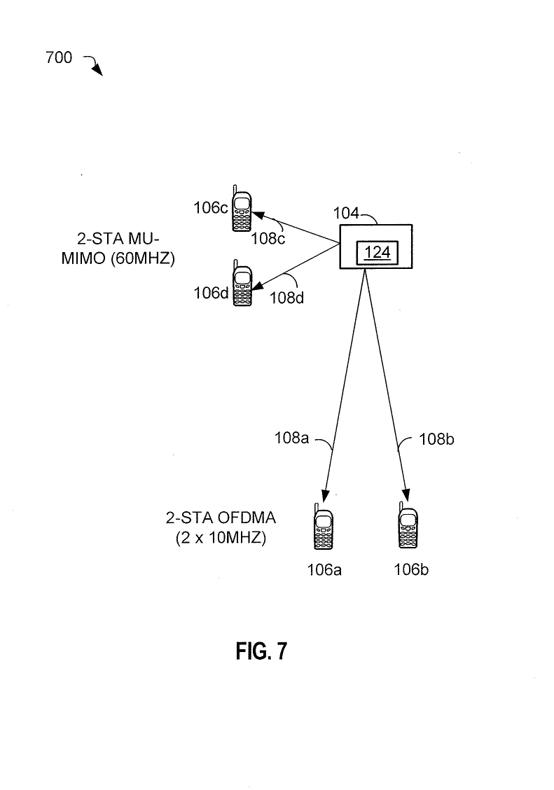

FIG. 3 illustrates various exemplary components that may be utilized in the packet generator based on packet type field 224 within the wireless device 202 of FIG. 2. For example, the packet generator based on packet type field 224, as previously described in connection with FIG. 2, may comprise a packet type determiner module 302 and a signal field parser 304. Although FIG. 3 illustrates these two modules, the present application is not so limited and the packet generator based on packet type field 224 may comprise more, fewer or different modules configured to perform the steps, processes or operations as will be described in more detail in connection with any of FIGS. 4-12 below. The packet type determiner module 302 may be configured to determine a packet type for generation based at least on information that is queued for transmission to one or more devices. Once the type of packet has been determined, the packet type determiner module 302 may communicate the determination to the signal field parser module 304. The signal field parser module 304 may be configured to generate a packet having an indication of the determined packet type included in a packet type field of a signal field, as will be described in more detail below. The signal field parser module 304 may additionally parse at least a portion of the remainder of bits of the signal field into one or more specific fields, the specific fields parsed and generated based on the specific type of packet indicated in the packet type field, as will be described in more detail below. Certain aspects of the present disclosure support utilizing OFDMA techniques, MU-MIMO techniques, SU-MIMO techniques, or mixing MU-MIMO and OFDMA techniques in the frequency domain in a same PPDU based at least in part on a value of a packet-type field in a SIG field of the PPDU. In some implementations corresponding to mixing MU-MIMO and OFDMA techniques, a first portion of the PPDU bandwidth may be transmitted as a MU-MIMO transmission and a second portion of the PPDU bandwidth may be transmitted as an OFDMA transmission, or vice versa. Such a mixing implementation may be described in more detail in connection with FIGS. 7-9 below. Moreover, although FIGS. 4-6 and 8-9 show a packet type field and/or the additional fields, parsed and generated based on an indication in the packet type field, located in a particular signal field (e.g., the HE-SIG1 field) the present application is not so limited. For example, the packet type field and/or the additional fields may be located in another HE-SIG field (e.g., the HE-SIG0 field), another new high efficiency field, or a legacy field of the PPDU. Alternatively, the packet type packet type field and additional field(s) may be located in different preamble fields (e.g., one or more of the fields in the HE-SIG0 field and the remaining fields in the HE-SIG1 field).

FIG. 4 illustrates a diagram of a physical layer data unit (PPDU) 400 having a first high efficiency signal field (HE-SIG0) 408 and a second high efficiency signal field (HE-SIG1) 410 that may be employed within the wireless communication system 100 of FIG. 1. As shown in FIG. 4, the PPDU 400 may comprise a legacy preamble portion including at least a legacy short training field (L-STF) 402, a legacy long training field (L-LTF) 404, and a legacy signal (L-SIG) field 406. Legacy fields (e.g., the L-STF, L-LTF, L-SIG) 402, 404, 406 may have configurations or formats that are decodable by legacy STAs operating according to an earlier standard (e.g., a legacy 802.11a/b/n standard) as well as by high efficiency wireless (HEW) STAs operating according to a related but advanced higher efficiency standard (e.g., a HEW 802.11ac standard). The PPDU 400 may additionally include a high efficiency preamble portion comprising a first high efficiency signal field (HE-SIG0 field) 408, a second high efficiency signal field (HE-SIG1 field) 410, and one or more high efficiency short and/or long training fields (e.g., HE-STF/LTF fields) 412. The HE-SIG0 field 408, the HE-SIG1 field 410, and the HE-STF/LTF fields 412 may be decodable by the HEW STAs operating according to the related but advanced higher efficiency standard (e.g., the HE 802.11ac standard) but not by the legacy STAs. Because the HE-SIG0 field 408 and the HE-SIG1 field 410 may be decoded by any HEW STA receiving the PPDU 400, they are considered “common signal fields.” The PPDU 400 may additionally include a data portion 414 for transmitting data. There may be some SIG fields that may only be decoded and processed by a subset of the HEW STAs. These SIG fields may be known as per-user SIG fields. In HEW networks, the common SIG fields may be transmitted in every 20 MHz band of the entire packet bandwidth. This enables STAs belonging to another BSS, i.e., an OBSS, to defer its transmissions according to time intervals advertised by the packet.

In some implementations, the HE-SIG0 field 408 may comprise a total of 24 bits and may be encoded across two symbols for delay spread protection. The HE-SIG0 field 408 may comprise a duration field 422, a long guard interval field 424 and a cyclical redundancy check and tail field CRC+tail field 426. In the 802.11ac standard, high data rate packets may include a very high throughput (VHT) signaling (SIG) field (not shown). However, the VHT-SIG field does not include a duration field since an 802.11ac-compatible receiver already utilizes the duration within the legacy signal (L-SIG) field 406 to determine the number of OFDM symbols in the PPDU. In HEW applications, the L-SIG field 406 may not have delay spread protection. For this reason, a duration field (not shown) in the L-SIG field cannot be reliably decoded by the receiver during HEW operation. The HE-SIG0 field 408 may have delay spread protection and may include the duration field 422, which may comprise 9 bits for indicating an estimated duration required to transmit the PPDU 400. In some other implementations, the duration field 422 may instead comprise 10 bits or 11 bits instead of 9 bits. Although the HE-SIG0 field 408 has delay spread protection, the HE-SIG1 field 410 may or may not have delay spread protection. Thus, the long GI field 424 in the HE-SIG0 field 408 may comprise 1 bit for indicating whether the HE-SIG1 field 410 and the rest of the packet 400 will be generated and transmitted having delay spread protection. The CRC+tail field 426 may comprise at least an 8-bit cyclical redundancy check and at least a 6-bit tail. Accordingly, the CRC+tail field 426 may comprise at least 14 bits and may be utilized to perform error checking of the HE-SIG0 field 408. The CRC+tail field 426 may additionally be utilized for HEW auto-detect.

In some implementations, the HE-SIG1 field 410 may comprise 48 bits and may span either 2 or 4 OFDM symbols. Thus, in some implementations, the HE-SIG0 field 408 and the HE-SIG1 field 410 may, together, comprise 72 bits, and may be separately encoded, rather than encoded as a single SIG field as is done conventionally. In some implementations, the HE-SIG0 field 408 and the HE-SIG1 field 410 may be generated and transmitted adjacently to one another within the PPDU 400. The HE-SIG1 field 410 may comprise a bandwidth (BW) field 432, a packet-type field 434, additional fields 436 (as will be described in more detail below), a field 438 which may include bits reserved for later utilization as well as the conventional 8-bit cyclical redundancy check, and a tail field 440.

The BW field 432 may comprise 2 bits for indicating the bandwidth of the PPDU packet. For example, the BW field 432 may be set to “0” for a bandwidth of 20 MHz, “1” for a bandwidth of 40 MHz, “2” for a bandwidth of 80 MHz, and “3” for a bandwidth of 160 MHz or 80+80 MHz. The packet-type field 434 may comprise 2 bits for indicating one of 4 possible downlink packet types in HEW, as shown in TABLE 1 below.

TABLE 1

| Packet Type field | Type of Downlink |
|---|---|
| 0, 0 | SU-MIMO packet |
| 0, 1 | MU-MIMO packet |
| 1, 0 | OFDMA packet |
| 1, 1 | Multi-portion packet |

For example, a bit combination of 0,0 may indicate a single user (SU) multiple-input multiple-output (MIMO) packet. A bit combination of 0,1 may indicate a multiple-user (MU) MIMO packet. A bit combination of 1,0 may indicate an OFDMA packet. And a bit combination of 1,1 may indicate a multi-portion packet comprising at least a first MU-MIMO or OFDMA portion and a second MU-MIMO or OFDMA portion. However, the present application is not limited to the above-mentioned bit combinations for indicating the specific packet type, and any of the above-mentioned 2-bit combinations may be utilized to respectively indicate the 4 above-mentioned packet types. Each of the above types of DL packet types are described in more detail below.

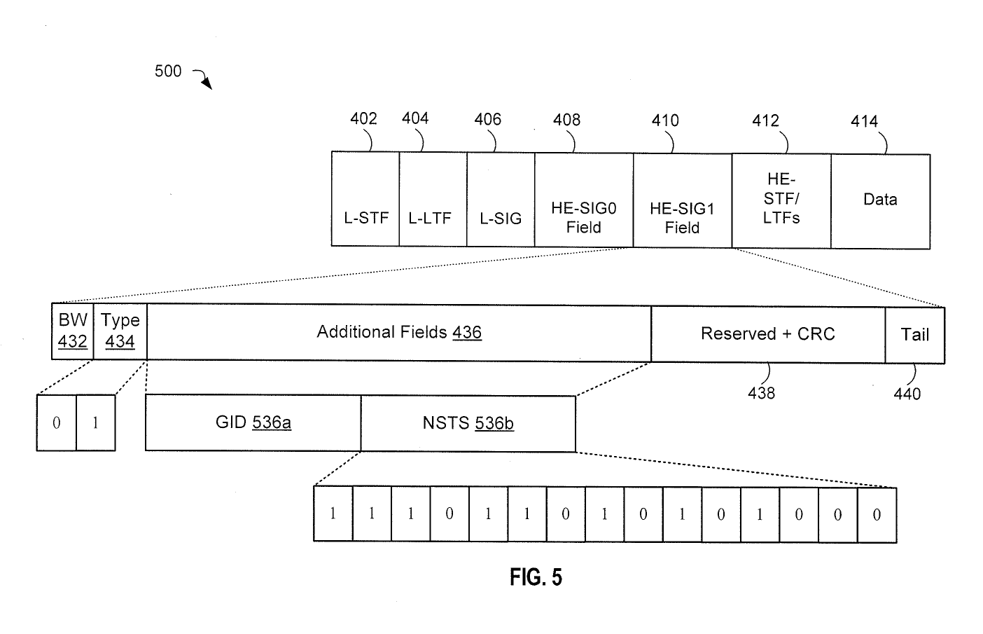

The HE-SIG1 field 410 may further include the additional fields 436, the bits of which may be dynamically allocated and processed based at least in part on the packet type indicated in the packet-type field 434. Thus, the processing and allocation of the bits in for the additional fields 436 may be a function of the contents of the packet-type field 434. How the additional fields 436 are allocated and processed for each of the 4 above-mentioned packet types will be described in more detail in connection with FIGS. 5-12 below.

FIG. 5 illustrates a format of a HE-SIG field 410 for a MU-MIMO PPDU 500, in accordance with an exemplary implementation. The PPDU 500 may comprise each of the fields as previously described in connection with the PPDU 400 of FIG. 4. As shown, the type field 434 of the HE-SIG1 field 410 may include bit values 0,1, which may indicate that the PPDU 500 is a MU-MIMO packet. In such implementations, based on the type field 434 having the value indicating the MU-MIMO packet, the additional fields 436 may comprise a group ID (GID) field 536a and a number of space time streams (NSTS) field 536b.

The GID field 536a may indicate the group of users with which the MU-MIMO PPDU packet 500 is associated. A 6-bit GID field 536a may be sufficient where the number of users is limited to 4. However, an 11-bit GID field 536a may be desirable where the number of users is increased to 8, since utilizing a longer GID field (e.g., an 11-bit GID field 536a) may provide a lower rate of failure in successfully identifying a multi-user group (e.g., an 8-user group) selected from among a larger number of available wireless stations (STAs).The NSTS field 536b may comprise 15 bits for indicating a number of spatial streams allocated to each of the users identified in the GID field 536a. According to the 802.11ac standard, an NSTS field requires 3 bits per user and may allocate only between 0 and 4 spatial streams per user. For this reason, as the number of users increases, the conventional encoding scheme requires a linearly increasing number of bits for an NSTS field. This conventional encoding scheme is very bit-inefficient. Thus there is a need for a new spatial stream allocation encoding scheme, which does not rely on a linearly increasing number of bits as the maximum number of users increases.

Suppose the maximum number of users in an MU-MIMO packet is M and the maximum number of spatial streams per packet is N. Then the total number of possible spatial stream allocations is given by the number of solutions to:

x₁ +x₂+ . . . x_{M}=N, xᵢ≧0.

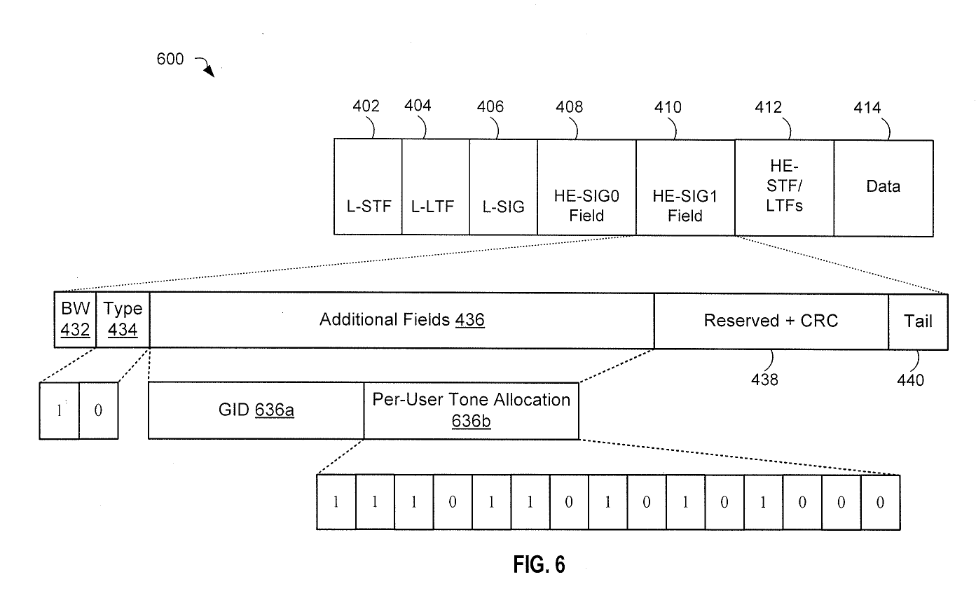

Thus, the number of solutions is ^{N+M-1}C_{M-1}. Accordingly, the best possible encoding scheme would require log₂(^{N+M-1}C_{M-1}) bits. However, for large values of M and N such an encoding scheme requires the use of an impractically large mapping table which needs to be shared between the transmitter and each receiver. The communication of such a large mapping table would negate the benefit of such an efficient encoding scheme. Thus, a simplified method for encoding the number of spatial streams allocated to each of a plurality of users is described below.

Where the maximum number of users in an MU-MIMO packet is M and the maximum number of spatial streams per packet is N, given any allocating (x₁, x₂, . . . , x_{M}), where xᵢ is an integer denoting the number of spatial streams for the i^{th} user, we can represent the allocation of spatial streams for all users utilizing a value of 1 for each spatial stream allocated to a particular user of the plurality of users, with a value of 0 indicating a separation of spatial stream allocations between each of the plurality of users. However, the use of 1 and 0 values are exemplary and not limiting. For example, any other notation differentiating between spatial stream indication and separation of spatial stream allocations between users may also be contemplated (e.g., reversing the roles of the 1 and 0 from that described above, a binary notation or any other form of encoding one value versus another value). Such notations may also apply to any other implementation described herein (e.g., FIGS. 6, 8 and 9). Thus, for each user, the number of spatial streams allocated to a particular user would be encoded as a string of 1s, the number of which corresponds to the number of spatial streams. For example, the NSTS field 536b as shown in FIG. 5 having an exemplary string of bits showing 111011010101000 would denote 3 spatial streams allocated to the first user, 2 spatial streams allocated to the second user, 1 spatial stream allocated to each of the third through fifth users and 0 spatial streams allocated to each of the sixth through eighth users since no 1s follow any of the last three 0s. Since the total number of spatial streams is less than or equal to N, the number of is requires is N and the number of 0s required is M−1. Thus, the number of bits required for the NSTS field 536b is N+M−1. For an 8-user MU-MIMO with a maximum of 8 spatial streams, the NSTS field 536b may comprise 15 bits, whereas utilizing the conventional 802.11ac encoding scheme would require 24 bits and would still be limited to allocating a maximum of 4 spatial streams to a particular user.

FIG. 6 illustrates a format of a HE-SIG field 410 for an OFDMA PPDU 600, in accordance with an exemplary implementation. The PPDU 600 may comprise each of the fields as previously described in connection with the PPDU 400 of FIG. 4. As shown, the type field 434 of the HE-SIG1 field 410 may include bit values 1,0 to indicate the OFDMA PPDU 400. In such implementations, based on the type field 434 having a value indicating a OFDMA packet the additional fields 436 may comprise a group ID (GID) field 636a and a per-user tone allocation field 636b. The GID field 636a may be substantially as described above in connection with the GID field 536a of FIG. 5. In MU-MIMO each user is allocated a number of spatial streams. By contrast, in OFDMA each user is allocated a number of frequency sub-bands, or tones.

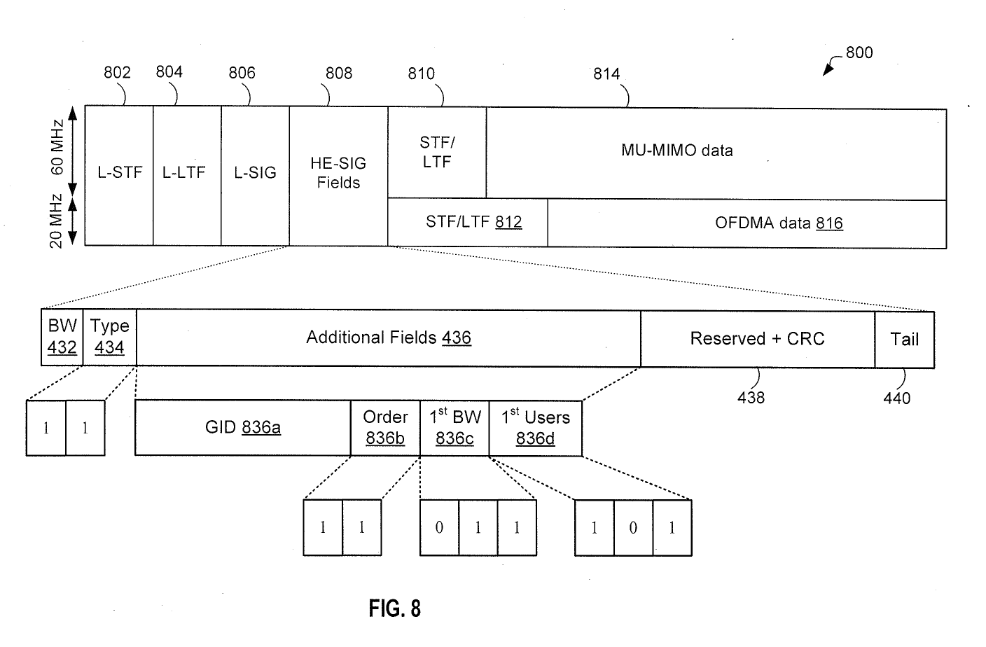

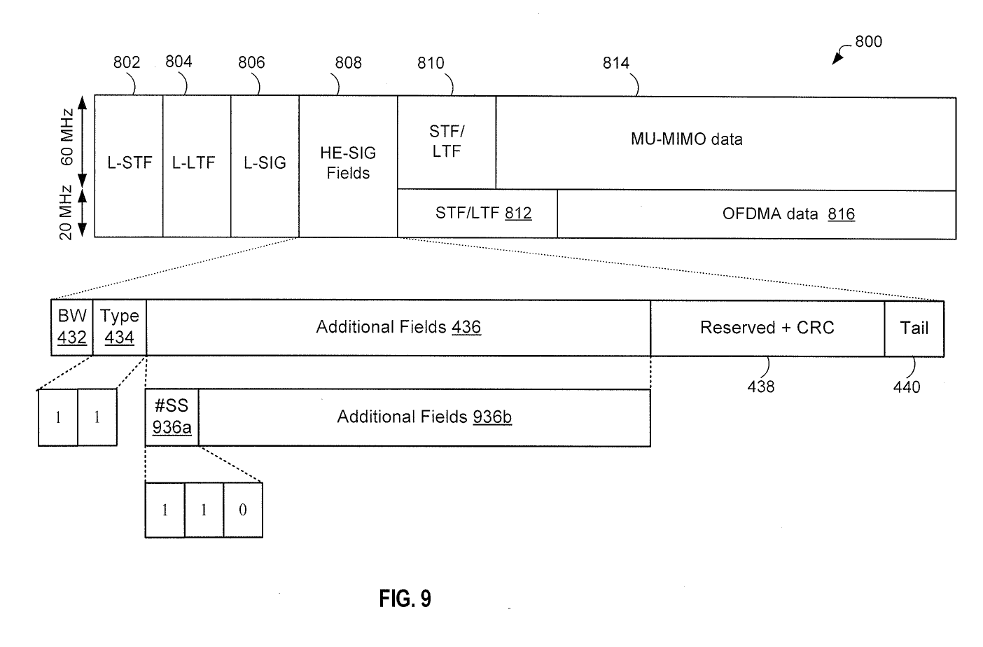

Because HEW STAs may operate utilizing packet bandwidths of 20 MHz, 40 MHz, 80 MHz or 160 MHz, there may be a significant number of ways in which those bandwidths may be allocated to a plurality of users if no minimum bandwidth is set for sub-band allocation. However, the encoding process may be significantly simplified by limiting the frequency sub-band allocations to a minimum allocation granularity that is a function of, or is based at least in part on, the total packet bandwidth. For example, when the total packet bandwidth is 20 MHz or 40 MHz, the minimum frequency sub-band allocation may be limited to 5 MHz allocations. When the total PPDU bandwidth is 80 MHz the minimum frequency sub-band allocation may be limited to 10 MHz allocations. And when the total bandwidth is 160 MHz the minimum frequency sub-band allocation may be limited to 20 MHz allocations. With such an implementation, an 80 MHz OFDMA PPDU may not have a 5 MHz tone allocation and a 160 MHz OFDMA PPDU may not have either a 5 MHz or a 10 MHz one allocation. However, the present application may not be so limited since a 80 MHz or 160 MHz OFDMA encoded packet having 5 MHz or 5 or 10 MHz tone allocations, respectively, may still be signaled as a multi-portion PPDU packet, as will be described in more detail in connection with FIGS. 8 and 9 below.

Thus, just as described above in connection with spatial stream allocation for MU-MIMO, for OFDMA tone allocation, the total number of possible tone allocations is given by the number of solutions to x₁+x₂+x₃+x₄+x₅+x₆+x₇+x₈=4 for a packet bandwidth of 20 MHz (e.g., 20 MHz can be divided into 4×5 MHz tones); and by the number of solutions to x₁+x₂+x₃+x₄+x₅+x₆+x₇+x₈=8 for a packet bandwidths of 40 MHz, 80 MHz and 160 Mhz (e.g., 40 MHz can be divided into 8 ×5 MHz tones, 80 MHz can be divided into 8×10 MHz tones, and 160 MHz can be divided into 8×20 MHz tones). Thus, for 8 users and 8 possible frequency sub-bands, the per-user tone allocation field 636b may comprise 15 bits, just as the NSTS field 536b previously described in connection with FIG. 5. For example, a per-user tone allocation field 636b as shown in FIG. 6 having an exemplary string of bits 111011010101000 as shown would denote 3 frequency sub-bands allocated to the first user, 2 frequency sub-bands allocated to the second user, 1 frequency sub-band allocated to each of the third through fifth users and 0 tones allocated to each of the sixth through eighth users since no 1s directly follow any of the last 3 0s.

As previously described, the present application may additionally contemplate mixing MU-MIMO and OFDMA techniques in the frequency domain in a same PPDU based at least in part on a value of a packet type field in the SIG field of the PPDU. FIG. 7 illustrates a block diagram of an access point 104 and stations 106a-106d in a mixed MU-MIMO and OFDMA system 700, in accordance with an exemplary implementation. For example, a portion of a bandwidth may be used for OFDMA transmissions and the remaining portion of the bandwidth may be used for MU-MIMO transmissions. In this implementation, the STAs 106a-b may utilize one 20 MHz channel and the AP 104 may send OFDMA transmissions 108a-b to the STAs 106a-b over the 20 MHz channel. In this aspect, the AP 104 may also send MU-MIMO transmissions 108c-d to STAs 106c-d over the remaining 60 MHz portion of the bandwidth. By sending a MU-MIMO packet to the STAs 106c-d over the previously un-used 60 MHz portion of the bandwidth, the AP 104 may increase throughput by using a combination of OFDMA and MU-MIMO transmissions in the same PPDU.

FIG. 8 illustrates a format of a HE-SIG field 808 for a multi-portion PPDU 800, in accordance with an exemplary implementation. Such a multi-portion or mixed PPDU 800 may be transmitted by a wireless device, such as the AP 104. As with the PPDU 400 of FIG. 4, the PPDU 800 may comprise a legacy preamble portion including a legacy short training field (L-STF) 802, a legacy long training field (L-LTF) 804, and a legacy signal field (L-SIG) 806. As previously stated, the legacy fields 802, 804, and 806 may be duplicated in every 20 MHz channel, as shown by those fields extending the entire height of the PPDU 800. The PPDU 800 may also comprise one or more high-efficiency signal fields (HE-SIG) 808 which contain certain signaling information for the PPDU 800. Although only a single HE-SIG field 808 is shown, the HE-SIG field 808 may comprise an HE-SIG0 field and a HE-SIG1 field (not separately shown), comprising similar fields or subfields, as previously described in connection with FIG. 4. As shown in FIG. 8, the MU-MIMO portion of the PPDU 800 packet occupies the top 60 MHz of the bandwidth. The MU-MIMO portion contains a STF/LTF field 810 and a MU-MIMO data portion 814. The OFDMA portion of the PPDU 800 occupies the bottom 20 MHz of the bandwidth and contains a STF/LTF field 812 and a OFDMA data portion 816. Although FIG. 8 shows the STF/LTF field 812 to be larger than the STF/LTF field 810, either field STF/LTF 810 or 812 may be any size such that, in some implementations, the STF/LTF field 810 may alternatively be larger or equal to the STF/LTF field 812. When transmitting the PPDU 800 the AP 104 may allocate part of its transmit power to transmit the MU-MIMO portion (fields 810 and 814) to one or more users (STAs) located close to the AP 104, while the remaining transmit power may be used to transmit the OFDMA portion (fields 812 and 816) to users (STAs) at the edge of the basic service area for the AP 104. In some other implementations, a first modulation and coding scheme (MCS) may be utilized for transmitting one portion of the PPDU 800 to a first group or subset of users (STAs) and a second MCS may be utilized for transmitting another portion of the PPDU 800 to a second group or subset of users (STAs). In such implementations, the allocation of STAs into the first subset versus the second subset may be based on one or more parameters (e.g., a distance to the AP (near versus edge STAs), a signal quality as determined or sensed by or at the AP including but not limited to signal to noise ratio (SNR), signal to interference plus noise (SINR) or some other signal strength metric).

The HE-SIG field 808 may signal the allocation of STAs across the MU-MIMO and OFDMA portions of the PPDU 700 packet bandwidth. For example, the HE-SIG fields 808 may comprise the bandwidth (BW) field 432, the packet-type field 434, the additional fields 436, the reserved+CRC field 438, and the tail field 440 as previously described in connection with FIG. 4. In some implementations as described above, the type field 434 may include bit values 1,1 to indicate a multi-portion PPDU . In such implementations, based on the type field 434 having a value indicating a multi-portion PPDU the additional fields 436 may comprise a group ID (GID) field 836a and at least a zone order field 836b, a first zone bandwidth (BW) field 836c, and a first zone user field 836d. The GID field 936a may be substantially as described above in connection with the GID fields 536a and 636a of FIGS. 5 and 6, respectively. The zone order field 836b may comprise 2 bits for indicating the type and ordering of the zones in the PPDU. For example, bit values 0,0 may signify a MU-MIMO first zone and a OFDMA second zone. Bit values 0,1 may signify a OFDMA first zone and a MU-MIMO second zone. Bit values 1,0 may signify a OFDMA first zone and another OFDMA second zone. Bit values 1,1 may signify a MU-MIMO first zone and a MU-MIMO second zone. However, the present application is not so limited and the zone order field 836b may utilize any other arrangement of the 2-bit series to indicate any of the 4 above-mentioned types of multi-portion PPDUs.

In some implementations, the zone order field 836b may comprise more than 2 bits in order to accommodate identification of more than two zones or portions of the PPDU each having different types. The first zone BW field 836c may comprise 3 bits for indicating the bandwidth that will be allocated for the first zone. The bandwidth allocated for the second zone may be determined by subtracting the total packet bandwidth from the first zone bandwidth indicated in the first zone BW field 836c. In some implementations, the first zone BW field 836c may comprise more than 3 bits. As a non-limiting example, where three zones or portions are supported, the first zone BW field 836c may comprise 6 bits, 3 for indicating the bandwidth that will be allocated to the first zone and 3 bits for indicating the bandwidth that will be allocated to the second zone. In such implementations, bandwidth allocated to the remaining third zone may be determined by subtracting the first and second zone bandwidths from the total packet bandwidth.

The first zone user field 836d may comprise 3 bits for indicating the number of users, between 1 and 8, that are to be associated with the first zone communications. The number of users not included in the first zone user field 836d may thus be allocated to the second zone communications. In some implementations, the first zone user field 836d may comprise more than 3 bits. As a non-limiting example, where three zones or portions are supported, the first zone user field 836d may comprise 6 bits, 3 for indicating the number of users associated with the first zone and 3 bits for indicating the number of users associated with the second zone. In such implementations, a number of users associated with the third zone may be determined by subtracting the number of users associated with the first and second zones from the total number of users indicated in the GID field 836a. Accordingly, the first zone user field 836d may be useful for parsing the GID field 836a. For example, in some implementations, the number, N, indicated in the first zone user field 836d may indicate that the first N users identified by the GID field 836a are to be associated with the first zone communication and the remainder of the users identified by the GID field 836a are to be associated with the second zone communications. Thus, in comparing the bit allocations between either of the MU-MIMO packet type of FIG. 5 or the OFDMA packet type of FIG. 6 and the multi-portion packet type of FIG. 8, the bits corresponding to the zone order field 836b, the first zone BW field 836c and the first zone user field 836d may be the same bits that were previously allocated to the NSTS field 436b of FIG. 4 or the per-user tone allocation field 636b of FIG. 6 based on the value in the packet type field 434. Furthermore, the GID field 836a is present for all multi-user packets. Where the packet is instead a single-user packet, the bits allocated to the GID fields as well as NSTS or per-user tone allocation fields for the multi-user packets may instead be reused or contrarily allocated to signal other single-user parameters.

FIG. 9 illustrates a format of a HE-SIG field 808 for a SU-MIMO PPDU 900, in accordance with an exemplary implementation. The PPDU 900 may comprise each of the fields as previously described in connection with the PPDU 800 of FIG. 8. However, the type field 434 of the HE-SIG field 808 may include bit values 0,0to indicate an SU-MIMO PPDU. In such implementations, based on the type field 434 having a value indicating a SU-MIMO PPDU, the additional fields 436 may comprise a number of spatial streams field 936a and a plurality of additional fields 936b. The number of spatial streams field 936a may comprise 3 bits for indicating the number of spatial streams allocated to the SU-MIMO packet (e.g., between 1-8 spatial streams). The remaining bits may be utilized to signal a host of SU-MIMO parameters, which may include for example, a 4-bit field for indicating the modulation and coding scheme (MCS), a 2-bit field for indicating the coding to be utilized, a 9-bit partial AID field or indicating an identity of the single user associated with the SU-MIMO packet, a 1-bit field for indicating whether beam-forming is utilized, and a 1-bit field for indicating whether space time block coding (STBC) is utilized (not shown). However, such fields are exemplary and one or more of the above-mentioned fields for signaling the host of SU-MIMO parameters may be omitted and/or one or more additional fields may be included in the remaining bits according to the particular implementation.

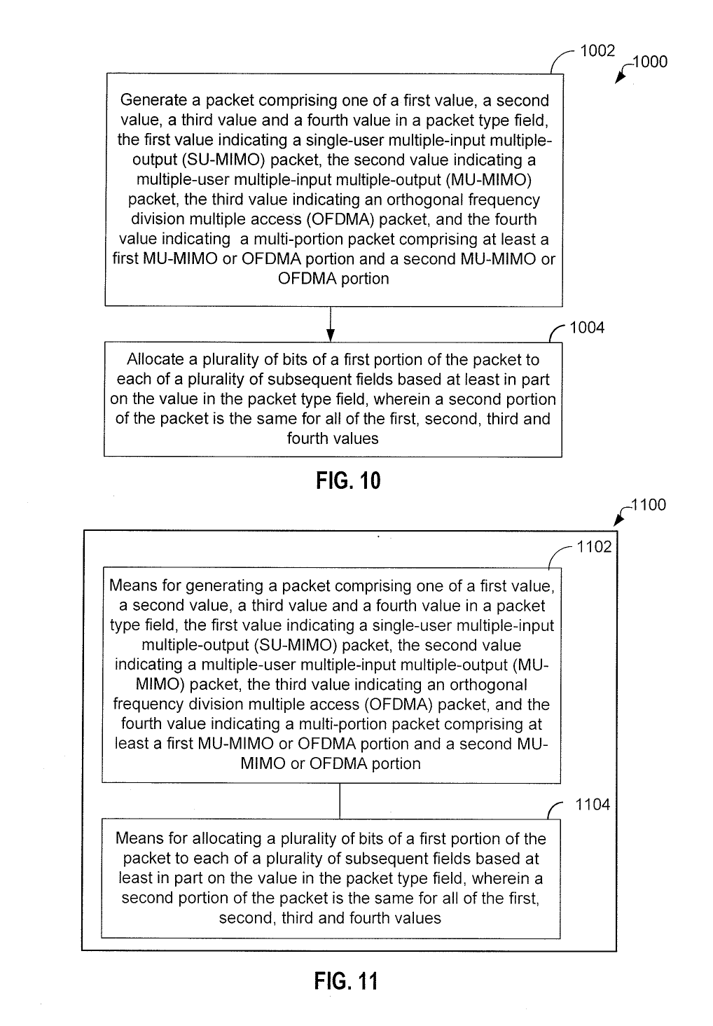

FIG. 10 is a flow chart of an aspect of a method of high efficiency wireless (HEW) communication, in accordance with an exemplary implementation. The method 1000 may be used to generate and transmit any of the packets described above. The packets may be generated by the packet generator 124 of the AP 104, for example, and may be transmitted by the AP 104 to one or more of the STAs 106a-106d shown in FIGS. 1 and/or FIG. 7. In addition, the wireless device 202 shown in FIG. 2 may represent a more detailed view of the AP 104, as described above. Thus, in one implementation, one or more of the steps in flowchart 1000 may be performed by, or in connection with, a processor, a memory, and/or transmitter, such as the processor 204, the memory 206, and transmitter 210 of FIG. 2, although those having ordinary skill in the art will appreciate that other components may be used to implement one or more of the steps described herein. Although blocks may be described as occurring in a certain order, the blocks can be reordered, blocks can be omitted, and/or additional blocks can be added.

At operation block 1002, the AP 104 may generate a packet comprising one of a first value, a second value, a third value and a fourth value in a packet type field. The first value may indicate a single-user multiple-input multiple-output (SU-MIMO) packet. The second value may indicate a multiple-user multiple-input multiple-output (MU-MIMO) packet. The third value may indicate an orthogonal frequency division multiple access (OFDMA) packet. The fourth value may indicate multi-portion packet comprising at least a first MU-MIMO or OFDMA portion and a second MU-MIMO or OFDMA portion.

At operational block 1004, the AP 104 may allocate a plurality of bits of a first portion of the packet to each of a plurality of subsequent fields based at least in part on the value in the packet type field. Moreover, a second portion of the packet (e.g., any common fields between FIGS. 5, 6, 8, and 9) are the same for all of the first, second, third and fourth values. For example, where a value of the packet type field indicates a multi-user packet (e.g., a MU-MIMO, OFDMA or multi-portion packet) the AP 104 may allocate a first subset of said plurality of bits to a group ID field as previously described in connection with FIGS. 5, 6 and 8.

The AP 104 may allocate a second subset of the plurality of bits to a field indicating a number of spatial streams allocated to each of a plurality of users when the value indicates the MU-MIMO packet, as previously described in connection with FIG. 5. In such implementations, the AP 104 may sequentially include in each of the second subset of the plurality of bits of the field indicating the number of spatial streams, a value of 1 for each spatial stream allocated to a particular user of the plurality of users for each of the plurality of users, and a value of 0 indicating a separation of spatial stream allocations between each of the plurality of users.

The AP 104 may allocate the second subset of the plurality of bits to a field indicating a number of frequency tones allocated to each of a plurality of users when the value indicates the OFDMA packet, as previously described in connection with FIG. 6. In such implementations, the AP 104 may sequentially include in each of the second subset of the plurality of bits of the field indicating the number of frequency tones, a value of 1 for each frequency tone allocated to a particular user of the plurality of users for each of the plurality of users, and a value of 0 indicating a separation of frequency tone allocations between each of the plurality of users.

When the value indicates the multi-portion packet, the AP 104 may allocate at least a second subset of the plurality of bits to a field indicating at least whether the first portion comprises MU-MIMO or OFDMA and whether the second portion comprises MU-MIMO or OFDMA, as described in connection with FIG. 8. The AP 104 may additionally allocate a third subset of the plurality of bits to a field indicating a frequency bandwidth allocated to the first portion and a fourth subset of the plurality of bits to a field indicating a number of users associated with the first portion.

The AP 104 may allocate a first subset of the plurality of bits to a field indicating a number of spatial streams allocated to the packet when the value indicates the SU-MIMO packet, as previously described in connection with FIG. 9. In such an implementation, the AP 104 may additionally allocate a second subset of the plurality of bits for signaling a host of SU-MIMO parameters, which may include for example, a field for indicating the MCS, a field for indicating the coding to be utilized, a partial AID field for indicating an identity of the single user associated with the SU-MIMO packet, a field for indicating whether beam-forming is utilized, and a field for indicating whether STBC is utilized.

FIG. 11 is a functional block diagram of an apparatus 1100 for wireless communication, in accordance with certain implementations described herein. Those skilled in the art will appreciate that the apparatus 1100 may have more components than the simplified block diagrams shown in FIG. 11. FIG. 11 includes only those components useful for describing some prominent features of implementations within the scope of the claims.

The apparatus 1100 comprises means 1102 for generating a packet comprising one of a first value, a second value, a third value and a fourth value in a packet type field. The first value may indicate a SU-MIMO packet, the second value a MU-MIMO packet, the third value an OFDMA packet, and the fourth value a multi-portion packet. In some implementations, the means 1102 can be configured to perform one or more of the functions described above with respect to blocks 1002 of FIG. 10. The means 1102 may comprise at least the processor 204 shown in FIG. 2, for example. In some implementations, the means 1102 may additionally comprise the memory 206 shown in FIG. 2, for example.

The apparatus 1100 may further comprise means 1104 for allocating a plurality of bits of a first portion of the packet to each of a plurality of subsequent fields based at least in part on the value in the packet type field. A second portion of the packet is the same for all of the first, second, third and fourth values, as described above in connection with FIG. 11. In some implementations, the means 1104 can be configured to perform one or more of the functions described above with respect to block 1004 of FIG. 10. The means 1104 may comprise at least the processor 204 shown in FIG. 2, for example. In some implementations, the means 1104 may additionally comprise the memory 206 shown in FIG. 2, for example.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of high efficiency wireless (HEW) communication, the method comprising:
generating a packet comprising one of a first value, a second value, a third value, and a fourth value in a packet type field, the first value indicating a single-user multiple-input multiple-output (SU-MIMO) packet, the second value indicating a multiple-user multiple-input multiple-output (MU-MIMO) packet, the third value indicating an orthogonal frequency division multiple access (OFDMA) packet, and the fourth value indicating a multi-portion packet comprising at least a first MU-MIMO or OFDMA portion and a second MU-MIMO or OFDMA portion, and
allocating a plurality of bits of a first portion of the packet to each of a plurality of subsequent fields based at least in part on the value of the packet type in the packet type field, wherein a second portion of the packet is the same for all of the first, second, third and fourth values.

2. The method of claim 1, wherein the packet type field and the plurality of subsequent fields are located within one or more signal (SIG) fields of the packet.

3. The method of claim 1, wherein allocating the plurality of bits comprises allocating a first subset of said plurality of bits to a group ID field for identifying each user associated with at least one portion of the packet.

4. The method of claim 1, wherein allocating the plurality of bits comprises allocating a second subset of the plurality of bits to a field indicating a number of spatial streams allocated to each of a plurality of users in the packet.

5. The method of claim 4, further comprising sequentially setting each of the bits of the field indicating the number of spatial streams to:
a first value for each spatial stream allocated to a particular user of the plurality of users for each of the plurality of users; and
a second value for indicating a separation of spatial stream allocations between each of the plurality of users.

6. The method of claim 1, wherein allocating the plurality of bits comprises allocating a second subset of the plurality of bits to a field indicating a number of frequency bands allocated to each of a plurality of users when the value of the packet type indicates the OFDMA packet.

7. The method of claim 6, further comprising sequentially setting each of the bits of the field indicating the number of frequency bands to:
a first value for each frequency band allocated to a particular user of the plurality of users for each of the plurality of users; and
a second value for indicating a separation of frequency band allocations between each of the plurality of users.

8. The method of claim 6, wherein a minimum bandwidth of the frequency bands is based at least in part on a value of a total packet bandwidth.

9. The method of claim 1, wherein allocating the plurality of bits comprises allocating, when the value of the packet type indicates the multi-portion packet, at least one of:
a second subset of the plurality of bits to a field indicating at least whether the first portion comprises MU-MIMO or OFDMA and whether the second portion comprises MU-MIMO or OFDMA,
a third subset of the plurality of bits to a field indicating a frequency bandwidth allocated to the first portion, and
a fourth subset of the plurality of bits to a field indicating a number of users associated with the first portion.

10. The method of claim 1, wherein allocating the plurality of bits comprises allocating a first subset of the plurality of bits to a field indicating a number of spatial streams allocated to the packet when the value of the packet type indicates the SU-MIMO packet.

11. The method of claim 1, wherein allocating the plurality of bits further comprises allocating a second subset of the plurality of bits to at least one field indicating at least one of: a modulation and coding scheme (MCS), a coding to be utilized, a partial AID, beamforming, and space time block coding (STBC),
wherein the second subset of the plurality of bits corresponds to a second subset of the plurality of bits allocated to a group ID field and a field indicating the number of spatial streams if the value of the packet type indicated a MU-MIMO packet.

12. The method of claim 1, wherein a signal field of the packet, generated as the SU-MIMO packet, comprises the packet type field and a field indicating a number of spatial streams allocated to a single user.

13. The method of claim 1, wherein a signal field of the packet, generated as the MU-MIMO packet, comprises the packet type field, a group ID field, and a field indicating a number of spatial streams allocated to each of a plurality of users.

14. The method of claim 1, wherein a signal field of the packet, generated as the OFDMA packet, comprises the packet type field, a group ID field, and a field indicating a number of frequency bands allocated to each of a plurality of users.

15. The method of claim 1, wherein a signal field of the packet, generated as the multi-portion packet, comprises the packet type field, a group ID field, a field indicating either the first MU-MIMO or OFDMA portion and either the second MU-MIMO or OFDMA portion, a field indicating a bandwidth of the first portion, and a field for indicating a number of users associated with the first portion.

16. An apparatus for high efficiency wireless (HEW) communication, the apparatus comprising:
a processor configured to:
generate a packet comprising one of a first value, a second value, a third value and a fourth value in a packet type field, the first value indicating a single-user multiple-input multiple-output (SU-MIMO) packet, the second value indicating a multiple-user multiple-input multiple-output (MU-MIMO) packet, the third value indicating an orthogonal frequency division multiple access (OFDMA) packet, and the fourth value indicating a multi-portion packet comprising at least a first MU-MIMO or OFDMA portion and a second MU-MIMO or OFDMA portion, and
allocate a plurality of bits of a first portion of the packet to each of a plurality of subsequent fields based at least in part on the value in the packet type field, wherein a second portion of the packet is the same for all of the first, second, third and fourth values.

17. The apparatus of claim 16, wherein the processor is configured to generate the packet type field and allocate the plurality of subsequent fields within one or more signal (SIG) fields of the packet.

18. The apparatus of claim 16, wherein the processor is configured to allocate the plurality of bits by allocating a first subset of said plurality of bits to a group ID field for identifying each user associated with at least one portion of the packet.

19. The apparatus of claim 16, wherein the processor is configured to allocate the plurality of bits by allocating a second subset of the plurality of bits to a field indicating a number of spatial streams allocated to each of a plurality of users in the packet.

20. The apparatus of claim 19, wherein the processor is further configured to sequentially set each of the bits of the field indicating the number of spatial streams to:
a first value for each spatial stream allocated to a particular user of the plurality of users for each of the plurality of users; and
a second value for indicating a separation of spatial stream allocations between each of the plurality of users.

21. The apparatus of claim 16, wherein the processor is configured to allocate the plurality of bits by allocating a second subset of the plurality of bits to a field indicating a number of frequency bands allocated to each of a plurality of users when the value of the packet type indicates the OFDMA packet.

22. The apparatus of claim 21, wherein the processor is further configured to sequentially set each of the bits of the field indicating the number of frequency bands to:
a first value for each frequency band allocated to a particular user of the plurality of users for each of the plurality of users; and
a second value for indicating a separation of frequency band allocations between each of the plurality of users.

23. The apparatus of claim 21, wherein the processor is further configured to determine a minimum bandwidth of the frequency bands based at least in part on a value of a total packet bandwidth.

24. The apparatus of claim 16, wherein the processor is configured to allocate the plurality of bits by allocating, when the value of the packet type indicates the multi-portion packet, at least one of:
a second subset of the plurality of bits to a field indicating at least whether the first portion comprises MU-MIMO or OFDMA and whether the second portion comprises MU-MIMO or OFDMA;
a third subset of the plurality of bits to a field indicating a frequency bandwidth allocated to the first portion; and
a fourth subset of the plurality of bits to a field indicating a number of users associated with the first portion.

25. The apparatus of claim 16, wherein the processor is configured to allocate the plurality of bits by allocating a first subset of the plurality of bits to a field indicating a number of spatial streams allocated to the packet when the value of the packet type indicates the SU-MIMO packet.

26. The apparatus of claim 25, wherein the processor is configured to allocate a second subset of the plurality of bits to at least one field indicating at least one of: a modulation and coding scheme (MCS), a coding to be utilized, a partial AID, beamforming, and space time block coding (STBC),
wherein the second subset of the plurality of bits correspond to a second subset of the plurality of bits allocated to a group ID field and a field indicating the number of spatial streams if the value of the packet type indicated a MU-MIMO packet.

27. The apparatus of claim 16, wherein a signal field of the packet, generated as the SU-MIMO packet, comprises the packet type field and a field indicating a number of spatial streams allocated to a single user.

28. The apparatus of claim 16, wherein a signal field of the packet, generated as the MU-MIMO packet, comprises the packet type field, a group ID field, and a field indicating a number of spatial streams allocated to each of a plurality of users.

29. The apparatus of claim 16, wherein a signal field of the packet, generated as the OFDMA packet, comprises the packet type field, a group ID field, and a field indicating a number of frequency bands allocated to each of a plurality of users.

30. The apparatus of claim 16, wherein a signal field of the packet, generated as the multi-portion packet, comprises the packet type field, a group ID field, a field indicating either the first MU-MIMO or OFDMA portion and either the second MU-MIMO or OFDMA portion, a field indicating a bandwidth of the first portion, and a field for indicating a number of users associated with the first portion.

31. A non-transitory computer-readable medium comprising code that, when executed, causes an apparatus to:
generate a packet comprising one of a first value, a second value, a third value, and a fourth value in a packet type field, the first value indicating a single-user multiple-input multiple-output (SU-MIMO) packet, the second value indicating a multiple-user multiple-input multiple-output (MU-MIMO) packet, the third value indicating an orthogonal frequency division multiple access (OFDMA) packet, and the fourth value indicating a multi-portion packet comprising at least a first MU-MIMO or OFDMA portion and a second MU-MIMO or OFDMA portion, and
allocate a plurality of bits of a first portion of the packet to each of a plurality of subsequent fields based at least in part on the value in the packet type field, wherein a second portion of the packet is the same for all of the first, second, third and fourth values.

32. The medium of claim 31, wherein the packet type field and the plurality of subsequent fields are located within one or more signal (SIG) fields of the packet.

33. The medium of claim 31, wherein allocating the plurality of bits comprises allocating a first subset of said plurality of bits to a group ID field for identifying each user associated with at least one portion of the packet.

34. The medium of claim 31, wherein allocating the plurality of bits comprises allocating a second subset of the plurality of bits to a field indicating a number of spatial streams allocated to each of a plurality of users in the packet.

35. The medium of claim 34, wherein the code, when executed, further causes the apparatus to sequentially set each of the bits of the field indicating the number of spatial streams to:
a first value for each spatial stream allocated to a particular user of the plurality of users for each of the plurality of users; and
a second value for indicating a separation of spatial stream allocations between each of the plurality of users.

36. The medium of claim 31, wherein allocating the plurality of bits comprises allocating a second subset of the plurality of bits to a field indicating a number of frequency bands allocated to each of a plurality of users when the value of the packet type indicates the OFDMA packet.

37. The medium of claim 36, wherein the code, when executed, further causes the apparatus to sequentially set each of the bits of the field indicating the number of frequency bands to:
a first value for each frequency band allocated to a particular user of the plurality of users for each of the plurality of users; and
a second value for indicating a separation of frequency band allocations between each of the plurality of users.

38. The medium of claim 36, wherein a minimum bandwidth of the frequency bands is based at least in part on a value of a total packet bandwidth.

39. The medium of claim 31, wherein allocating the plurality of bits comprises allocating, when the value of the packet type indicates the multi-portion packet, at least one of:
a second subset of the plurality of bits to a field indicating at least whether the first portion comprises MU-MIMO or OFDMA and whether the second portion comprises MU-MIMO or OFDMA;
a third subset of the plurality of bits to a field indicating a frequency bandwidth allocated to the first portion; and
a fourth subset of the plurality of bits to a field indicating a number of users associated with the first portion.

40. The medium of claim 31, wherein allocating the plurality of bits comprises allocating a first subset of the plurality of bits to a field indicating a number of spatial streams allocated to the packet when the value of the packet type indicates the SU-MIMO packet.

41. The medium of claim 40, wherein allocating the plurality of bits further comprises allocating a second subset of the plurality of bits to at least one field indicating at least one of: a modulation and coding scheme (MCS), a coding to be utilized, a partial AID, beamforming, and space time block coding (STBC),
wherein the second subset of the plurality of bits corresponds to a second subset of the plurality of bits allocated to a group ID field and a field indicating the number of spatial streams if the value of the packet type indicated a MU-MIMO packet.

42. The medium of claim 31, wherein a signal field of the packet, generated as the SU-MIMO packet, comprises the packet type field and a field indicating a number of spatial streams allocated to a single user.

43. The medium of claim 31, wherein a signal field of the packet, generated as the MU-MIMO packet, comprises the packet type field, a group ID field, and a field indicating a number of spatial streams allocated to each of a plurality of users.

44. The medium of claim 31, wherein a signal field of the packet, generated as the OFDMA packet, comprises the packet type field, a group ID field, and a field indicating a number of frequency bands allocated to each of a plurality of users.

45. The medium of claim 31, wherein a signal field of the packet, generated as the multi-portion packet, comprises the packet type field, a group ID field, a field indicating either the first MU-MIMO or OFDMA portion and either the second MU-MIMO or OFDMA portion, a field indicating a bandwidth of the first portion, and a field for indicating a number of users associated with the first portion.

46. An apparatus for high efficiency wireless (HEW) communication, the apparatus comprising:
means for generating a packet comprising one of a first value, a second value, a third value, and a fourth value in a packet type field, the first value indicating a single-user multiple-input multiple-output (SU-MIMO) packet, the second value indicating a multiple-user multiple-input multiple-output (MU-MIMO) packet, the third value indicating an orthogonal frequency division multiple access (OFDMA) packet, and the fourth value indicating a multi-portion packet comprising at least a first MU-MIMO or OFDMA portion and a second MU-MIMO or OFDMA portion; and
means for allocating a plurality of bits of a first portion of the packet to each of a plurality of subsequent fields based at least in part on the value in the packet type field, wherein a second portion of the packet is the same for all of the first, second third and fourth values.

47. The apparatus of claim 46, wherein the packet type field and the plurality of subsequent fields are located within one or more signal (SIG) fields of the packet.

48. The apparatus of claim 46, wherein the means for allocating is configured to allocate the plurality of bits by allocating a first subset of said plurality of bits to a group ID field for identifying each user associated with at least one portion of the packet.

49. The apparatus of claim 46, wherein the means for allocating is configured to allocate the plurality of bits by allocating a second subset of the plurality of bits to a field indicating a number of spatial streams allocated to each of a plurality of users in the packet.

50. The apparatus of claim 49, further comprising means for sequentially setting each of the bits of the field indicating the number of spatial streams to:
a first value for each spatial stream allocated to a particular user of the plurality of users for each of the plurality of users; and
a second value for indicating a separation of spatial stream allocations between each of the plurality of users.

51. The apparatus of claim 46, wherein the means for allocating is configured to allocate the plurality of bits by allocating a second subset of the plurality of bits to a field indicating a number of frequency bands allocated to each of a plurality of users when the value of the packet type indicates the OFDMA packet.

52. The apparatus of claim 51, further comprising means for sequentially setting each of the bits of the field indicating the number of frequency bands to:
a first value for each frequency band allocated to a particular user of the plurality of users for each of the plurality of users; and
a second value for indicating a separation of frequency band allocations between each of the plurality of users.

53. The apparatus of claim 51, wherein a minimum bandwidth of the frequency bands is based at least in part on a value of a total packet bandwidth.

54. The apparatus of claim 46, wherein the means for allocating is configured to allocate the plurality of bits by allocating, when the value of the packet type indicates the multi-portion packet, at least one of:
a second subset of the plurality of bits to a field indicating at least whether the first portion comprises MU-MIMO or OFDMA and whether the second portion comprises MU-MIMO or OFDMA;
a third subset of the plurality of bits to a field indicating a frequency bandwidth allocated to the first portion; and
a fourth subset of the plurality of bits to a field indicating a number of users associated with the first portion.

55. The apparatus of claim 46, wherein the means for allocating is configured to allocate the plurality of bits by allocating a first subset of the plurality of bits to a field indicating a number of spatial streams allocated to the packet when the value of the packet type indicates the SU-MIMO packet.

56. The apparatus of claim 55, wherein the means for allocating is configured to allocate a second subset of the plurality of bits to at least one field indicating at least one of:
a modulation and coding scheme (MCS), a coding to be utilized, a partial AID, beamforming, and space time block coding (STBC), wherein the second subset of the plurality of bits correspond to a second subset of the plurality of bits allocated to a group ID field and a field indicating the number of spatial streams if the value of the packet type indicated a MU-MIMO packet.

57. The apparatus of claim 46, wherein a signal field of the packet, generated as the SU-MIMO packet, comprises the packet type field and a field indicating a number of spatial streams allocated to a single user.

58. The apparatus of claim 46, wherein a signal field of the packet, generated as the MU-MIMO packet, comprises the packet type field, a group ID field, and a field indicating a number of spatial streams allocated to each of a plurality of users.

59. The apparatus of claim 46, wherein a signal field of the packet, generated as the OFDMA packet, comprises the packet type field, a group ID field, and a field indicating a number of frequency bands allocated to each of a plurality of users.

60. The apparatus of claim 46, wherein a signal field of the packet, generated as the multi-portion packet, comprises the packet type field, a group ID field, a field indicating either the first MU-MIMO or OFDMA portion and either the second MU-MIMO or OFDMA portion, a field indicating a bandwidth of the first portion, and a field for indicating a number of users associated with the first portion.
